(19) United States
(12) Patent Application Publication
(10) Pub. No.: US 2009/0177339 A1
(43) Pub. Date: Jul. 9, 2009

(54) Optimization and Mechanization of Periodic Flight

(76) Inventors: Robert H. Chen, Los Angeles, CA (US); Jason L. Speyer, Los Angeles, CA (US)

Correspondence Address: MICHAEL BLAINE BROOKS, P.C., P.O. BOX 1630, SIMI VALLEY, CA, 93062-1630, US

(21) Appl. No.: 12/355,473

(22) Filed: Jan. 16, 2009

Related U.S. Application Data
(63) Continuation of application No. 11/368,098, filed on Mar. 3, 2006.
(60) Provisional application No. 60/658,123, filed on Mar. 3, 2005.

(51) Int. Cl. G05D 1/00

(52) U.S. Cl. 701/3

(57) ABSTRACT

The implementation of periodic flight for enhancing aircraft's endurance or range is described having at least two components in the periodic flight embodiments. The first component is the trajectory optimization which determines the optimal periodic trajectory (such as altitude, velocity and flight path angle) that produces maximal endurance or range for a given fuel. The second component is the periodic guidance law which mechanizes the optimal periodic trajectory. For certain aircraft, periodic flight improves that aircraft's endurance or range over steady state flight.

### CROSS-REFERENCE TO RELATED APPLICATIONS

This application is a Continuation of U.S. Nonprovisional patent application Ser. No. 11/368,098, filed Mar. 3, 2006 to Robert H. Chen, Jason L. Speyer and Walton R. Williamson which claims the benefit of U.S. Provisional Application Ser. No. 60/658,123 filed Mar. 3, 2005, to Jason L. Speyer, Robert H. Chen, and Walton R. Williamson, entitled “Periodic and Skipping Guidance Law for Aerial Vehicles”, both documents are hereby incorporated herein by reference in their entirety for all purposes.

### BACKGROUND

1. Field of Endeavor

The invention relates to guidance, navigation and control of a vehicle and particularly pertains to periodic guidance improving an air vehicle's endurance and/or range.

2. State of the Technology

The guidance and control of a vehicle, particularly an air vehicle, may be represented by the linearization of the physical plant, i.e., the air vehicle, and may include stochastic, or time-varying, statistical characterizations, themselves possibly also characterized across pertinent frequency spectra. Air vehicle flight trajectories may be determined base on a cost index, a model of the system, and an optimization rule to drive the trajectory to minimize or maximize the cost index. The resulting preferred trajectories can be very large in number when attempts are made to relate them to discrete parameters such as the vehicle's position, its several energy states (e.g., kinetic, potential, and the energy stored in the propellants, if any), in the face of drag and varying atmospheric dynamic pressure. For certain aircraft, periodic flight improves that aircraft's endurance (e.g., time aloft) or range, over steady-state flight. There remains a need for robust, real-world implementations of periodic guidance laws particularly for air vehicles.

### BRIEF SUMMARY OF THE EXEMPLARY EMBODIMENTS

Several exemplary embodiments of the invention are summarized as follows and are described for purposes of illustration and not for purposes of limitation. An apparatus, system and method for maintaining one or more air vehicles on a periodic trajectory includes: a navigation system for estimating the state of the aerial vehicle including at least the altitude, velocity and flight path angle; a set of stored periodic trajectories defining at least the optimal altitude, velocity, and flight path angle designed to maximize endurance or range for a given weight; means of generating steering and attitudinal control signals to maintain the aircraft along a prescribed trajectory which can include one or more processing units taking in sensor feedback information and comparing that information with reference commands and executing computer-readable instructions having variables including one or more filter and/or gain coefficients generated according to steps further described below. In order to compare and correct the nominal or preferred trajectory at any point in time, method for measuring the difference between the nominal trajectory and the estimated trajectory through assignment of an index time of the nominal trajectory may be applied. In addition, a regulator for generating modified controls is designed to enhance the nominal controls defined for the associated index time based on the difference between the estimated state and the nominal or preferred state at the associated index time. The foregoing calculations and determination of control signals may be done onboard the air vehicle or at one or more locations not within the air vehicle. If control signals are generated onboard, they may be transferred to the control effectors such as airfoil actuators or thrust vector control jets or nozzles via an electrical bus or an optical fiber. Radio frequency and optical transmitters may be used by off-board computing stations to uplink the control command to the onboard receivers and control effectors. Accordingly, a means of transmitting the modified control signals to the aircraft for the purpose of correcting the difference between the nominal and estimated states may be provided in a distributed system. Air vehicle states may be measured or derived to assess the estimated trajectory and to develop control corrective signals. One or more processing units may be employed for providing the one or more steering or control effector commands by taking in at least one state estimate, where the processor executes steps to compare the state estimate to the nominal or preferred state using at least one prescribed index time and thereby may generate corrective signals for the one or more control effectors. In executing these steps, the apparatus may refine or optimize the actual trajectory of the air vehicle to enhance endurance, (i.e., loiter time,) or range, by outputting the determined command to the air vehicle or aircraft control system.

The invention in its several embodiments is robust as to its ability to incorporate one or more estimates of the state of the air vehicle. For example, an exemplary embodiment of the invention includes an apparatus for maintaining air vehicles on a periodic trajectory wherein at least one of the trajectory analyzing processing, or computing units, receives estimates of vehicle weight. The trajectory analyzing processing may also receive, and include in its steps of trajectory determination and/or flight path corrections, estimates of inertial navigation quantities that may include linear acceleration and angular rate of the air vehicle that may be derived quantities from position, velocity and attitude state measurements that may be earth-relative and as for angular rate and/or angular acceleration, these may be measured or estimated from inertial measurement devices such as rate gyroscopes and an array of linear accelerometers. The trajectory analyzing processing may also receive, and include in its steps of trajectory determination and/or flight path corrections estimates of air mass motion quantities relative to the aircraft.

As trajectory corrective determinations are made, corrective command signals may be sent to effectors onboard the air vehicle typically for purposes of changing the magnitude and direction of the velocity vector of the air vehicle. Accordingly, the processing steps may provide one or more command signals which may include: an engine throttle command; an engine power setting command; an engine fuel or fuel rate command; one or more aircraft aerodynamic commands; one or more aircraft attitude commands; aircraft velocity commands; and aircraft airspeed commands.

The trajectory refinements provided by the one or more processors may be based on coefficients and/or derived signals that may be affected by stored trajectories that may be used as references of preferred trajectories for comparative purposes, for example to generate an error signal vector. The trajectory analysis processing unit may draw from a stored set of trajectories that may have been selected as those likely to maximize or generate enhanced down range air vehicle performance. In addition, the trajectory analysis processing unit may draw from a stored set of trajectories may have been selected as those likely to maximize or generate enhanced cross range. Further, the trajectory analysis processing unit may draw from a stored set of trajectories that may have been selected as those likely to achieve downrange and cross range constraints within the maximum downrange and cross range of the vehicle. In addition, the trajectory analysis processing unit may draw from a stored set of trajectories that may have been selected as those likely to maximize or generate enhanced loiter time around a desired terrestrial location. The trajectory analysis processing unit may draw from the multiple stored trajectories that may be stored where each trajectory may have been based on a different, constant weight of the vehicle from the other and the processing unit may perform interpolation between trajectories for intermediate weight values of the air vehicle that may be entered or estimated. The interpolation techniques across the weight of the various stored trajectories may be linear and nonlinear algorithms and may include neural-network architectures or other learning architectures.

Index times may be used in the analysis of the stored preferred trajectory against the estimated actual trajectory or location. Accordingly, the index time may be selected to minimize the difference between the stored nominal trajectory and the state estimate based on a cost index.

The onboard processing of the air vehicle typically includes steering processing and may include addition autopilot processing. This processing may be referred to as a regulator as this processing attempts to generate error signals between a reference state and an estimate of the actual state of the air vehicle. The regulating signals are typically based on these error signals and may be conditioned by additional filtering and/or amplification or attenuation according to the one or more regulator gain values. Accordingly, the regulating signals may be determined by using the state space of the aircraft vehicle generated from the estimated measurements or may be determined from the command outputs to be sent to the aircraft, or a combination thereof. The regulator gains may be variable and may themselves be estimated or stored and drawn and applied in the regulator signal calculation according to time and/or vehicle states and may be determined via linear quadratic feedback control methods known to those of ordinary skill in the art of modern control systems. In addition, the regulator gains may be determined by classical feedback control methods known to those of ordinary skill in the art in classical control systems. The regulator gains may be determined by linear quadratic Gaussian feedback control methods and robust control methodologies known to those of ordinary skill in the art of modern stochastic control systems.

The invention, in its several embodiments, may also accommodate waypoint steering that may be incorporated into the flight mission or profile of the air vehicle. Accordingly, the trajectory analysis processing unit may draw from a stored set of trajectories that may have been selected as those likely to maintain a desired rate of turn in addition to generate an enhanced range and/or endurance. Further the trajectory analysis processing unit may receive additional commands such as one or more desired way points comprised of, for example, a first waypoint latitude, a first waypoint longitude, and a first waypoint altitude. Accordingly, the trajectory analysis processing unit may estimate the one or more differences between the current estimated air vehicle state and the desired waypoint. Stored trajectories may be interpolated to determine a command to enhance range and/or endurance while still guiding the vehicle to the waypoint. Accordingly, the regulator may produce commands to maintain the vehicle on a periodic trajectory while maintaining the desired rate of turn an onboard processor or processor not within the air vehicle determines outputs the modified commands via any one of several exemplary means of communication previously described between the regulator processing and the onboard effectors such as airfoil and/or thrust vector control actuators and engine throttle control units.

### BRIEF DESCRIPTION OF THE DRAWINGS

For a more complete understanding of the present invention in its several embodiments, and for further features and advantages, reference is now made to the following description taken in conjunction with the accompanying drawings, in which:

FIG. 1 illustrates an exemplary functional block diagram of periodic guidance law topology;

FIG. 2 illustrates an exemplary flow diagram of the generation of autopilot commands;

FIG. 3 illustrates in a graph exemplary periodic loitering trajectories showing altitude versus time;

FIG. 4 illustrates in a graph exemplary periodic loitering trajectories showing velocity versus time;

FIG. 5 illustrates in a graph exemplary periodic loitering trajectories showing flight path angle versus time;

FIG. 6 illustrates in a graph exemplary periodic loitering trajectories showing down range versus cross range;

FIG. 7 illustrates in a graph exemplary periodic loitering trajectories showing angle-of-attack versus time;

FIG. 8 illustrates in a graph exemplary periodic loitering trajectories showing thrust versus time;

FIG. 9 illustrates in a graph exemplary periodic loitering trajectories showing bank angle versus time;

FIG. 10A illustrates in a graph exemplary periodic loitering trajectory showing 3-dimensional view for a 200 pound (lb) cruise weight;

FIG. 10B illustrates in a graph exemplary periodic loitering trajectory showing 3-dimensional view for a 170 lb cruise weight;

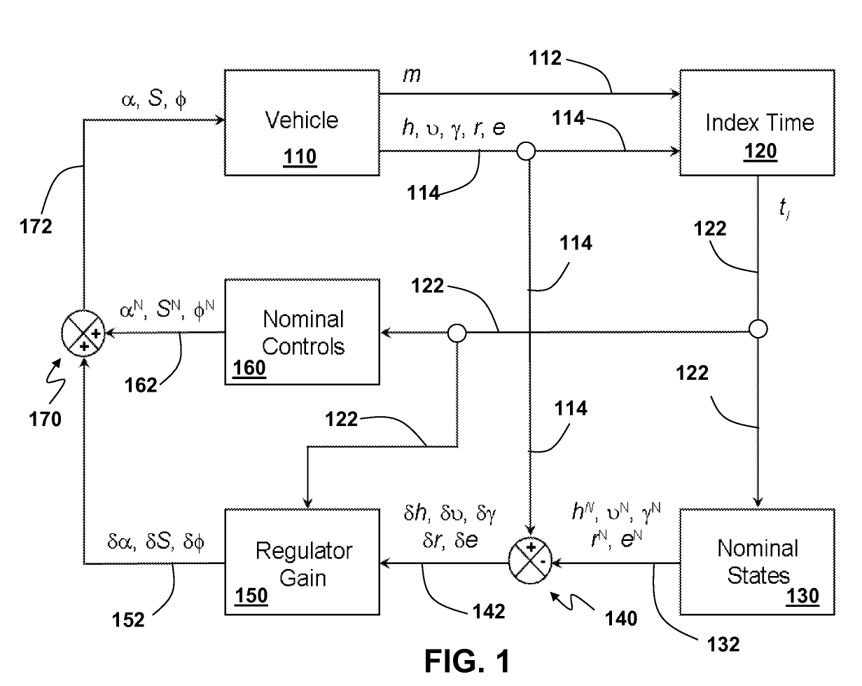

FIG. 1C illustrates in a graph exemplary periodic loitering trajectory showing 3-dimensional view for a 140 lb cruise weight;

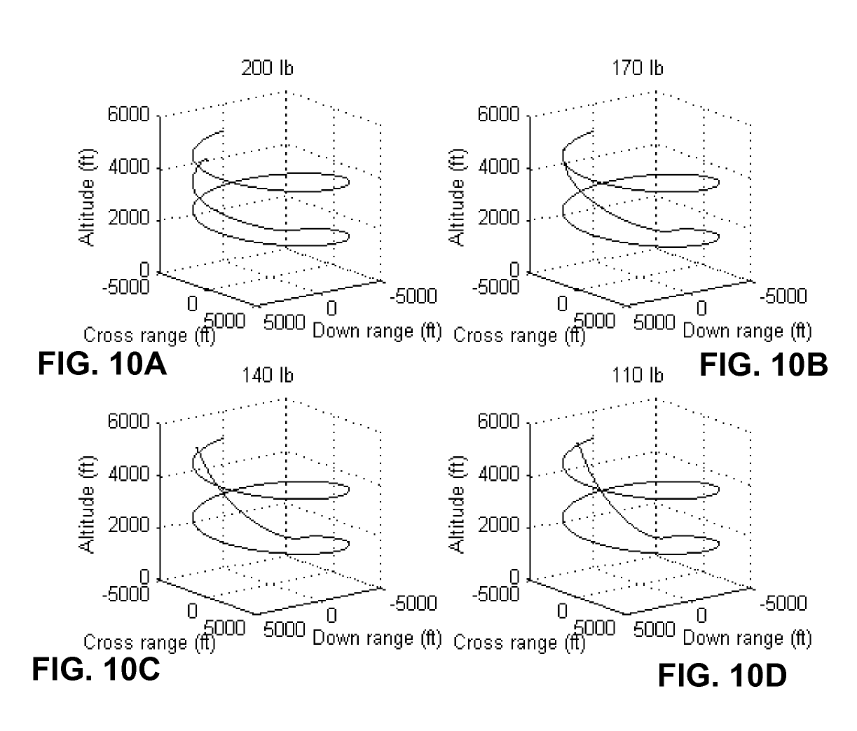

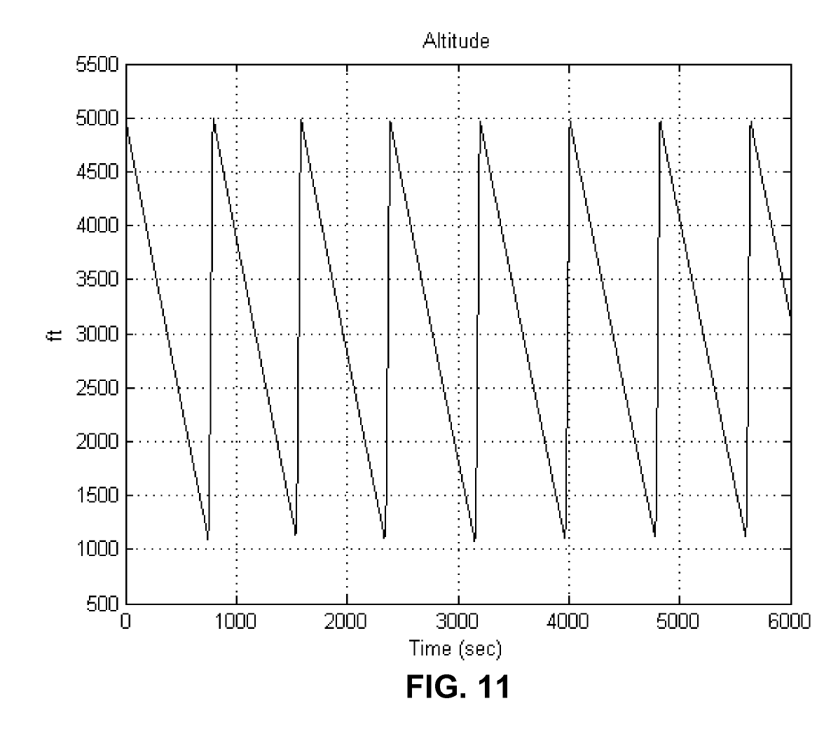

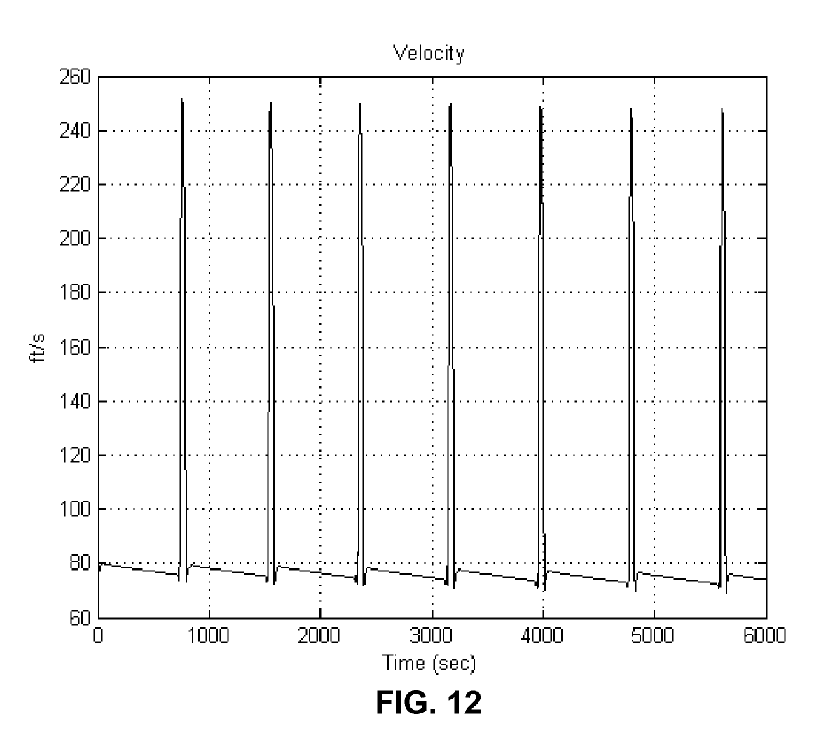

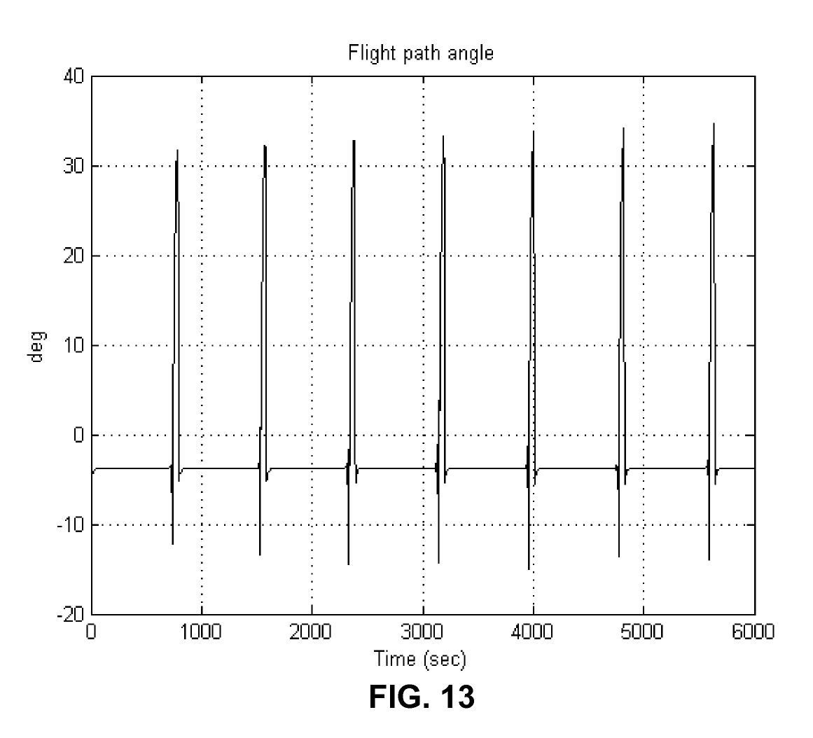

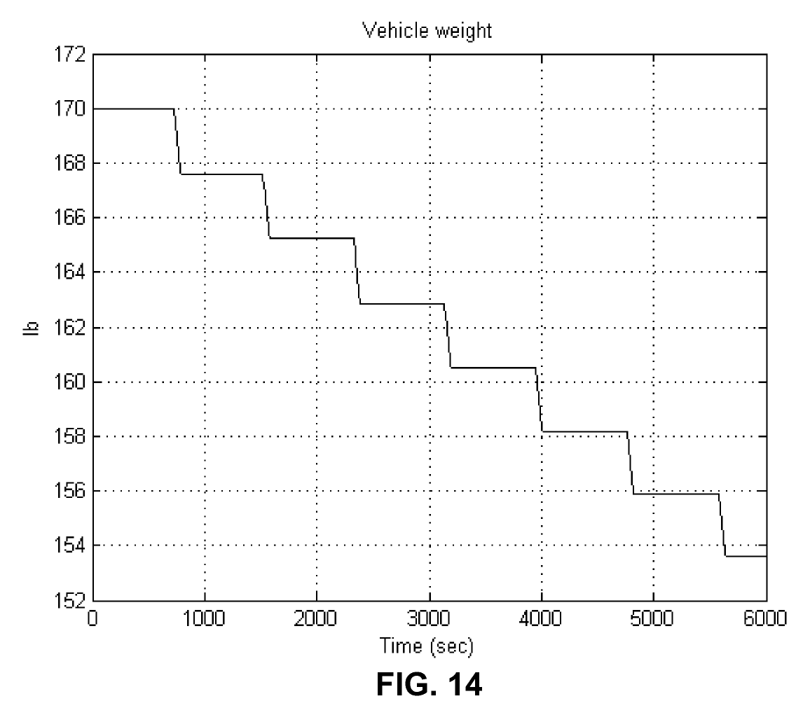

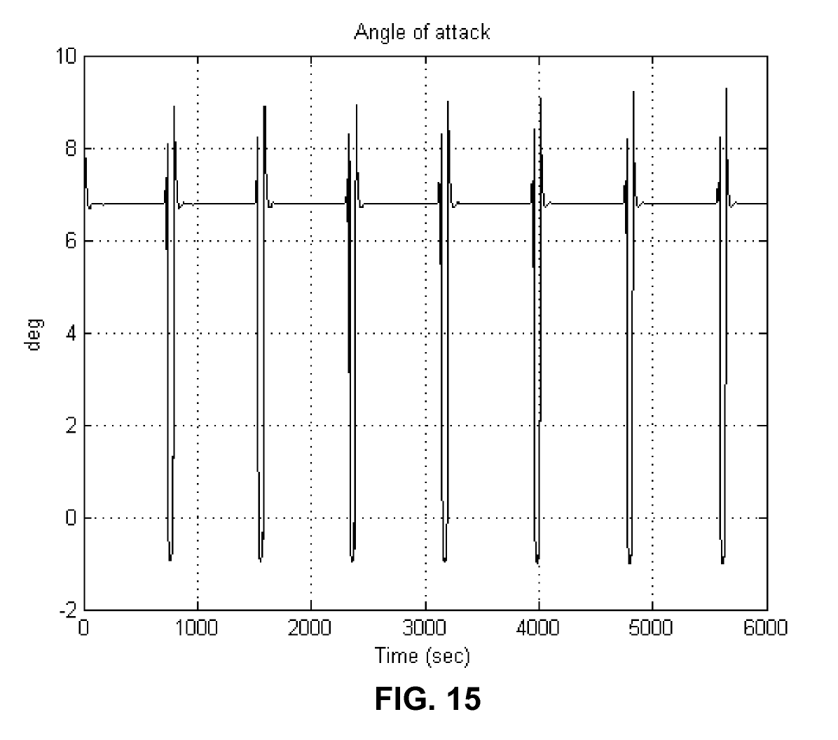

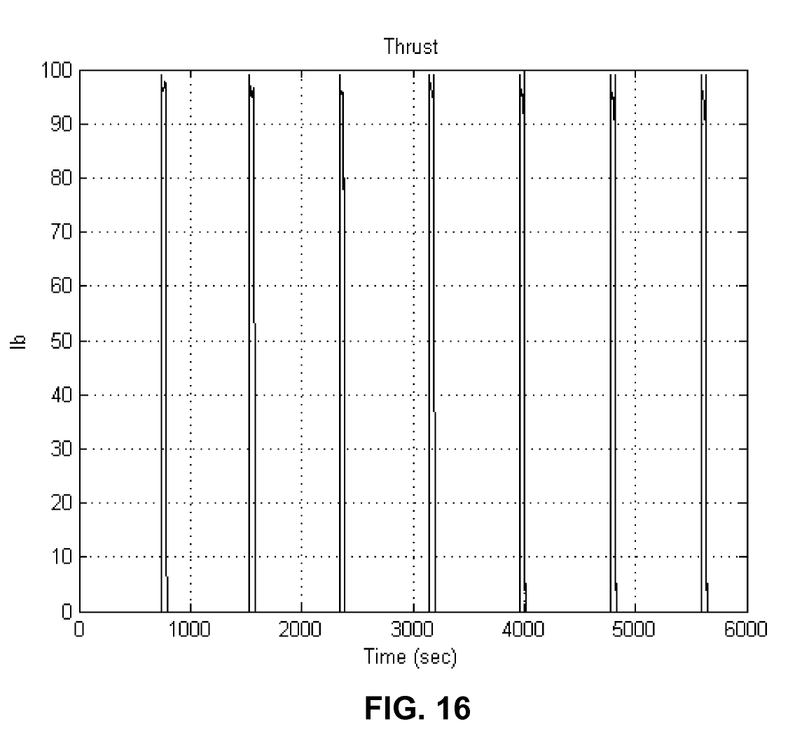

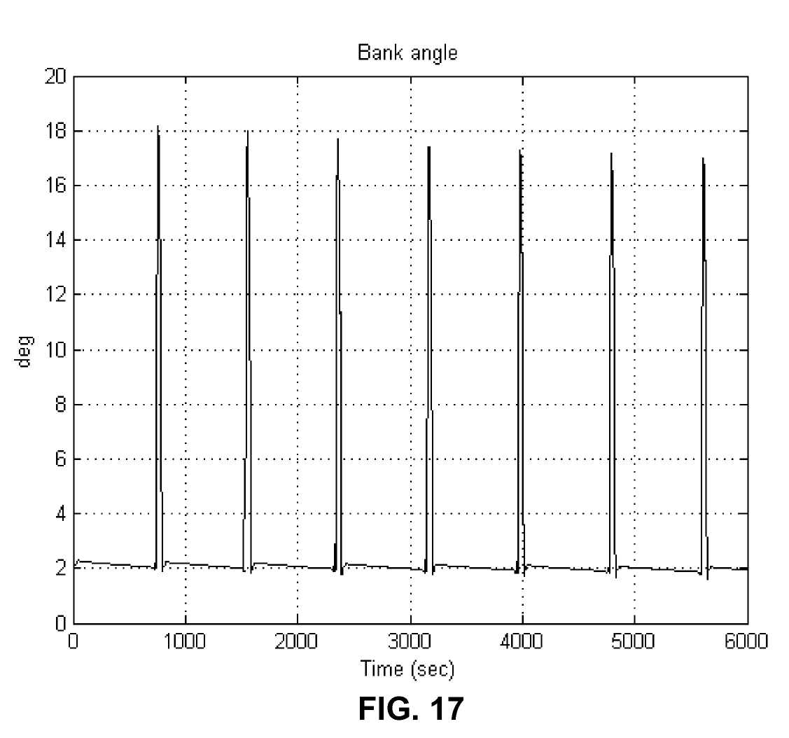

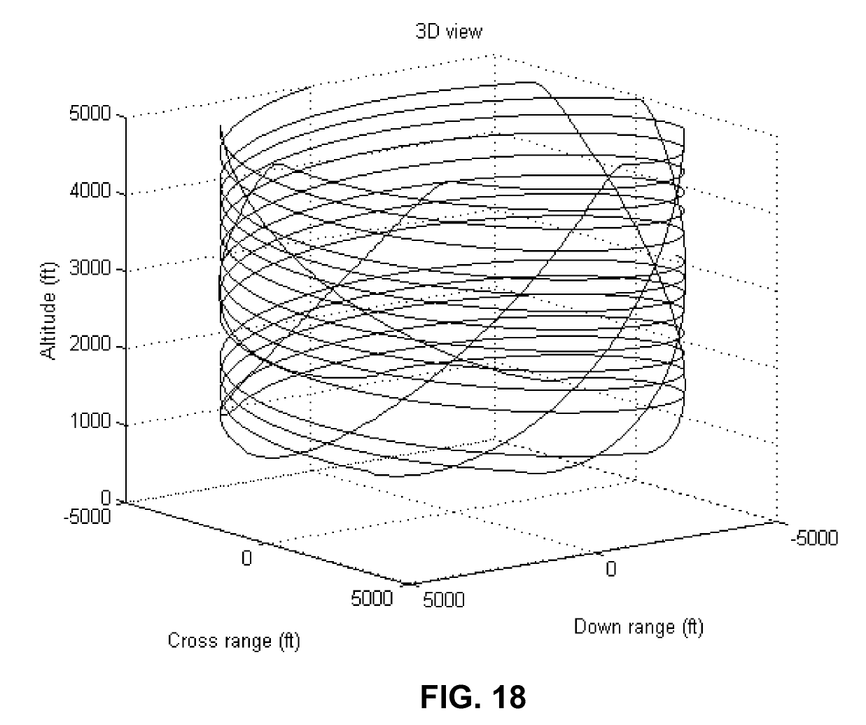

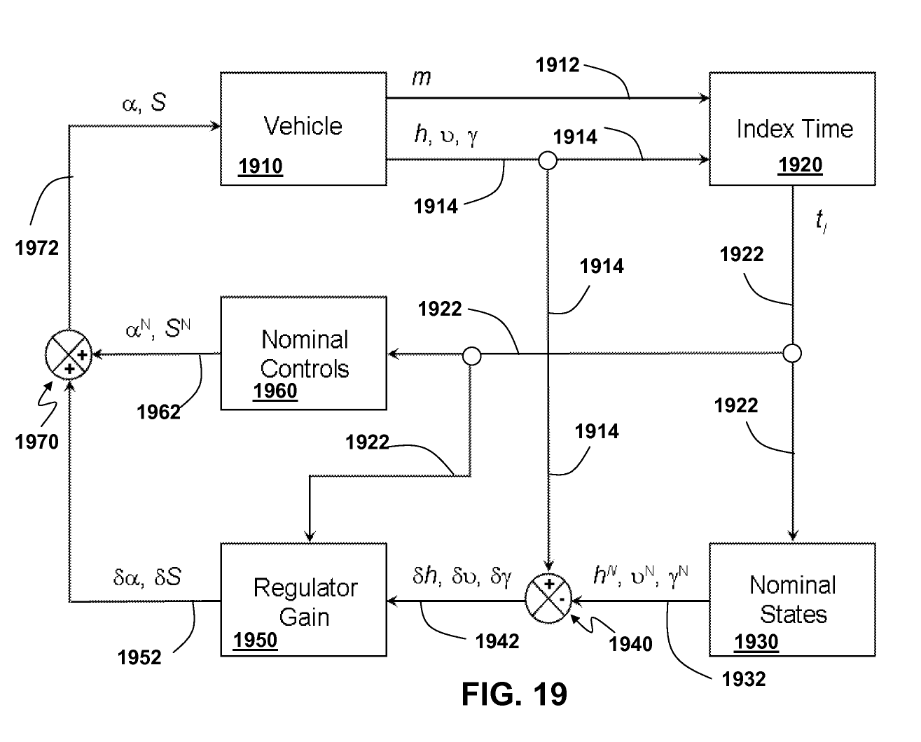

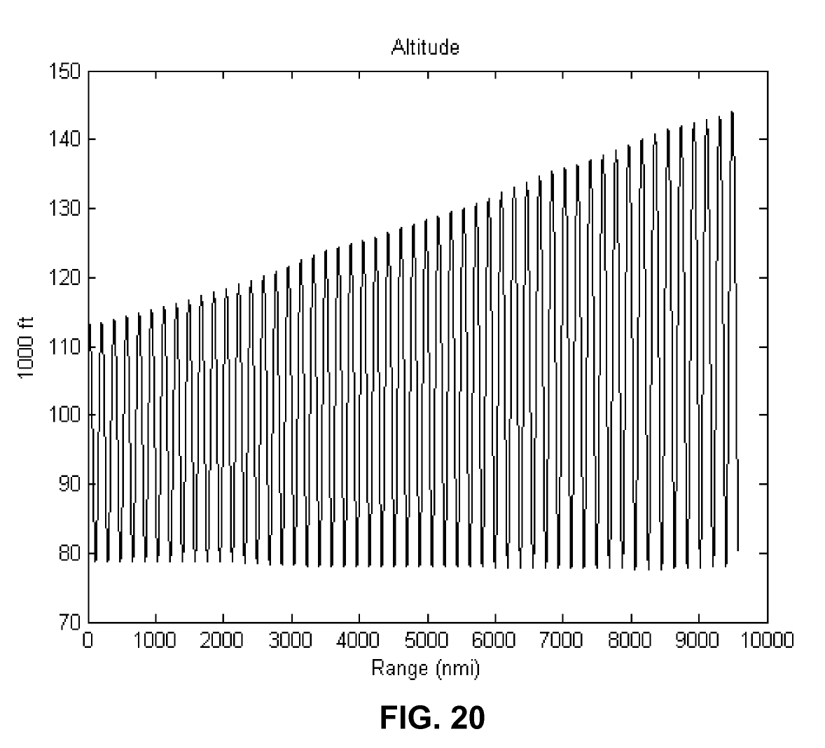

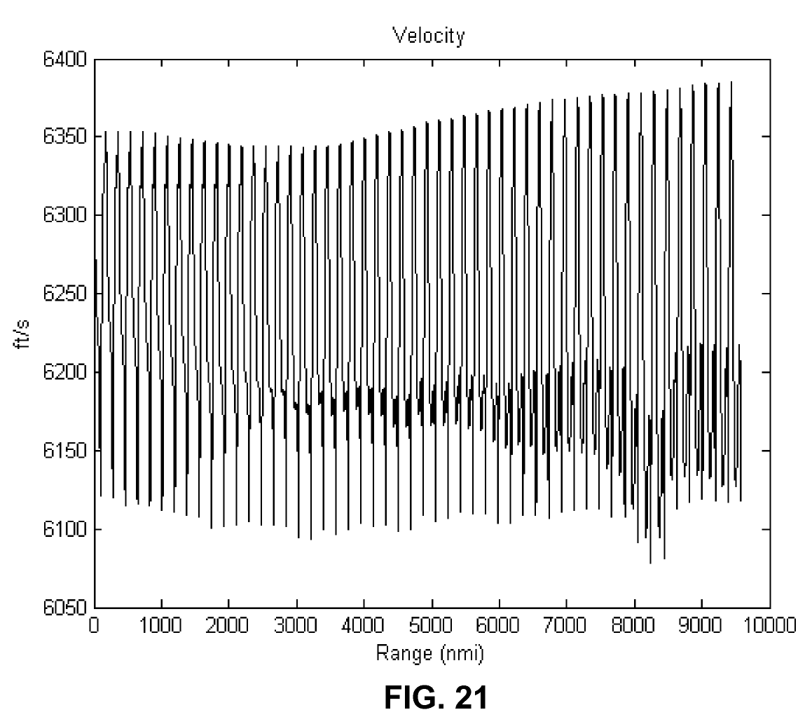

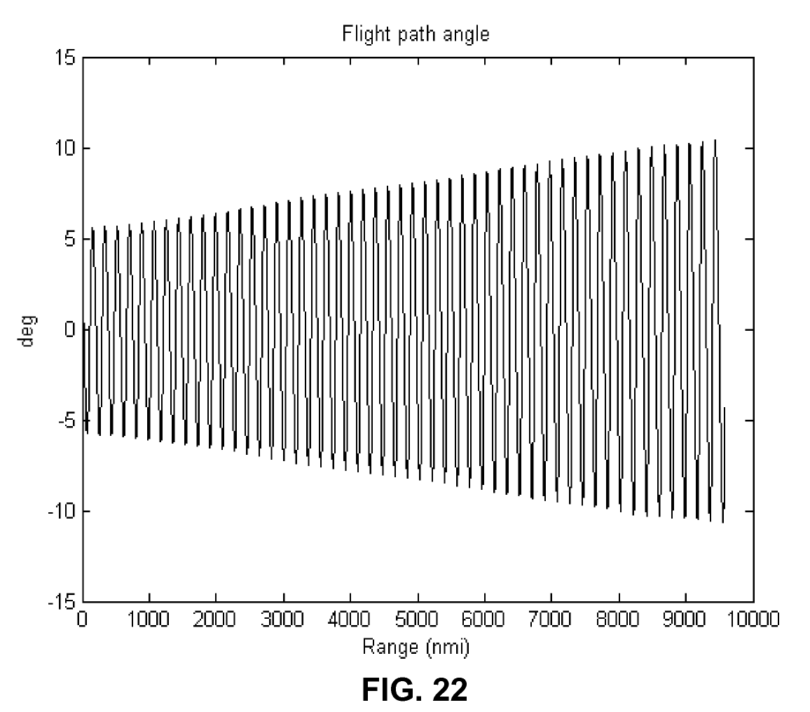

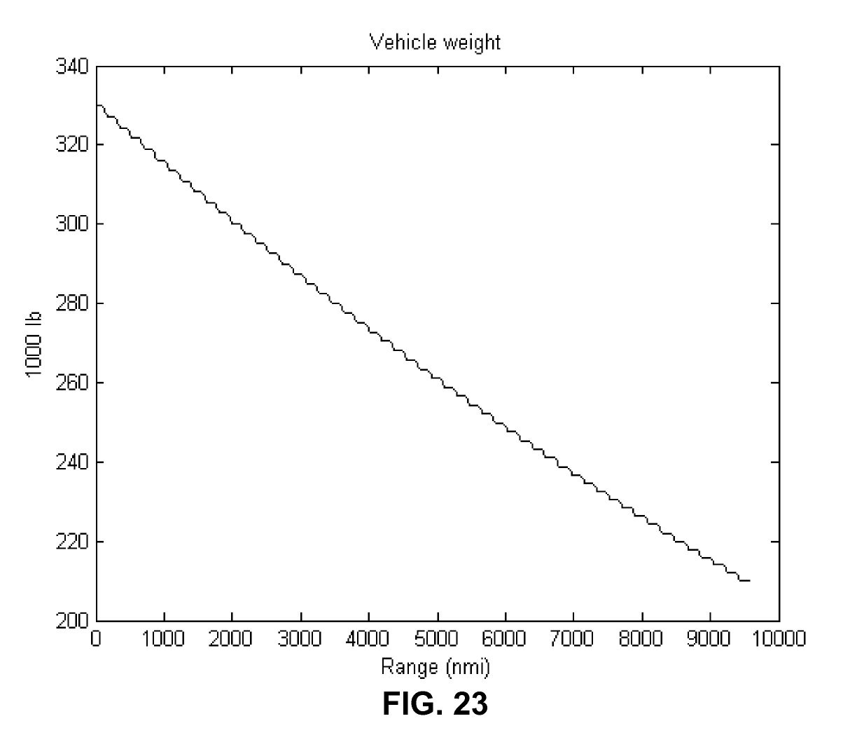

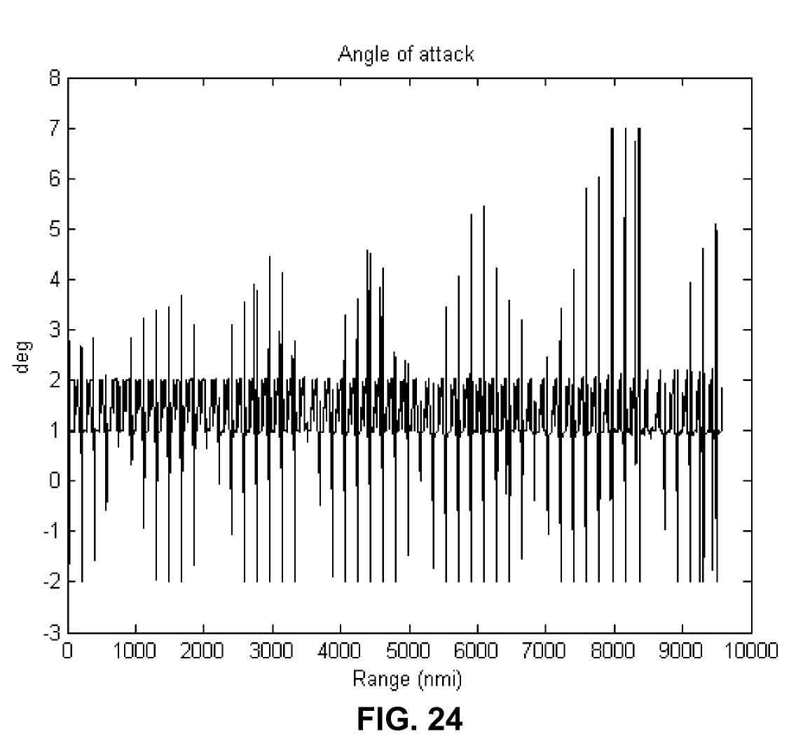

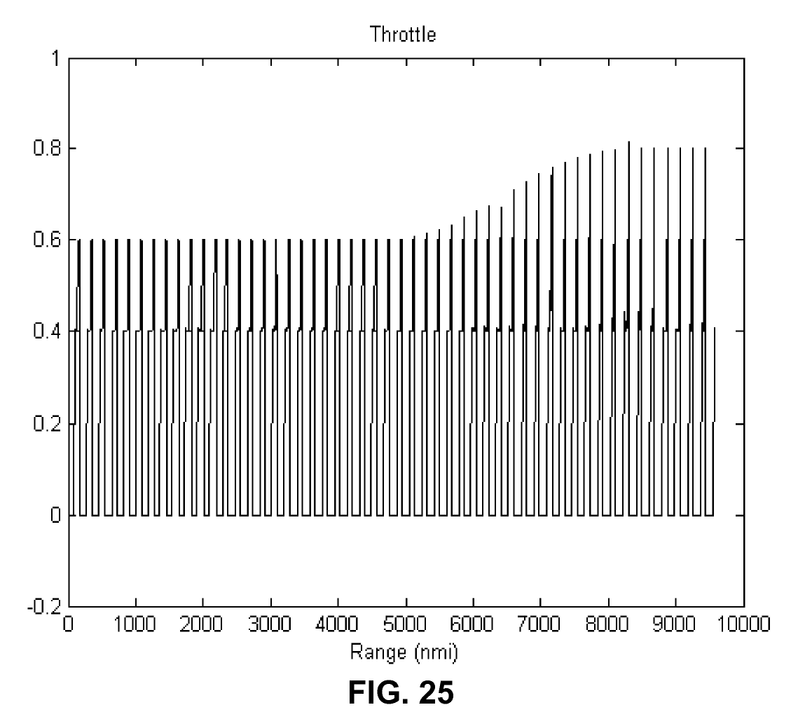

FIG. 10D illustrates in a graph exemplary periodic loitering trajectory showing 3-dimensional view for a 110 lb cruise weight;

FIG. 11 illustrates in a graph an exemplary periodic loitering trajectory showing altitude versus time;

FIG. 12 illustrates in a graph an exemplary periodic loitering trajectory showing velocity versus time;

FIG. 13 illustrates in a graph an exemplary periodic loitering trajectories showing flight path angle versus time;

FIG. 14 illustrates in a graph exemplary time history of vehicle weight during the execution of an exemplary periodic loitering trajectory;

FIG. 15 illustrates in a graph exemplary time history of angle-of-attack during the execution of an exemplary periodic loitering trajectory;

FIG. 16 illustrates in a graph exemplary time history of thrust during the execution of an exemplary periodic loitering trajectory;

FIG. 17 illustrates in a graph exemplary time history of bank angle during the execution of an exemplary periodic loitering trajectory;

FIG. 18 illustrates in a graph an exemplary loitering trajectory showing 3-dimensional view;

FIG. 19 illustrates in an exemplary functional block diagram a periodic cruise guidance law topology that may be employed for flying straight ahead;

FIG. 20 illustrates in a graph exemplary periodic cruise trajectory showing altitude versus time;

FIG. 21 illustrates in a graph exemplary periodic cruise trajectory showing velocity versus time;

FIG. 22 illustrates in a graph exemplary periodic cruise straight ahead trajectory showing flight path angle velocity versus time;

FIG. 23 illustrates in a graph exemplary time history of vehicle weight during the execution of an exemplary periodic cruise trajectory;

FIG. 24 illustrates in a graph exemplary time history of angle-of-attack during the execution of an exemplary periodic cruise trajectory; and

FIG. 25 illustrates in a graph exemplary time history of throttle during the execution of an exemplary periodic cruise trajectory.

### DETAILED DESCRIPTION

The equations of motion for a vehicle flying over a non-rotating, spherical Earth are

$$\begin{matrix}\dot{h} = v sin γ & [ 1 ] \\ \dot{v} = \frac{{T}_{A } cos α - {T}_{N} sin α - D}{m} - g sin γ & [ 2 ] \\ \dot{γ} = \frac{{T}_{A} sin α + {T}_{N} cos α + L}{mv} cos φ - \frac{g cos γ}{v} + \frac{v cos γ}{{R}_{e} + h} & [ 3 ] \\ {\dot{r}}_{d} = v cos γ cos ψ \frac{{R}_{e}}{{R}_{e} + h} \frac{1}{cos \frac{{r}_{c}}{{R}_{e}}} & [ 4 ] \\ \dot{ψ} = \frac{{T}_{A } sin α + {T}_{N} cos α + L}{mv cos γ} sin φ + \frac{v cos γ cos ψ tan \frac{{r}_{c}}{{R}_{e}}}{{R}_{e} + h} & [ 5 ] \\ {\dot{r}}_{c} = v cos γ sin ψ \frac{{R}_{e}}{{R}_{e} + h} . & [ 6 ]\end{matrix}$$

The states are the altitude h, velocity v, flight path angle γ, down range r_{d}, heading angle ψ and cross range r_{c}. The controls are the angle-of-attack α, throttle S and bank angle φ. L and D are the lift and drag, respectively. T_{A} and T_{N} are the axial thrust and normal thrust, respectively. m is the vehicle mass. g is the acceleration due to the gravity. Rₑ is the radius of the Earth. This vehicle model is used as the starting point for the implementation of the periodic flight with maximal endurance (also termed optimal periodic loitering) and the periodic flight with maximal range (also termed optimal periodic cruise).

### Optimal Periodic Loitering

In this section, the optimization and mechanization of periodic loitering are described. The objective is to have the vehicle circle above a point on the ground as long as possible with a given amount of fuel. Since the vehicle flies in a small region, a flat Earth can be assumed and equations numbers 1-6 become

$$\begin{matrix}\dot{h} = v sin γ & [ 7 ] \\ \dot{v} = \frac{{T}_{A} cos α - {T}_{N} sin α - D}{m} - g sin γ & [ 8 ] \\ \dot{γ} = \frac{{T}_{A } sin α + {T}_{N} cos α + L}{mv} cos φ - \frac{g cos γ}{v} & [ 9 ] \\ {\dot{r}}_{d} = v cos γ cos ψ & [ 10 ] \\ \dot{ψ} = \frac{{T}_{A} sin α + {T}_{N } cos α + L}{mv cos γ} sin φ & [ 11 ] \\ {\dot{r}}_{c} = v cos γ sin ψ . & [ 12 ]\end{matrix}$$

Define two new states as

$$r = \sqrt{{r}_{d}^{2} + {r}_{c}^{2}}$$

$$e = ψ - {tan}^{- 1} \frac{{r}_{c}}{{r}_{d}} .$$

By using equations 10, 11 and 12,

\dot{r}=vcosγ cos e [13]

$$\dot{e} = \frac{{T}_{A} sin α + {T}_{N} cos α + L}{mv cos γ} sin φ - \frac{v}{r} cos γ sin e . \qquad ( 14 )$$

Therefore, the equations of motion become equation nos. 7, 8, 9, 13 and 14 where the states are now h, v, γ, r and e. This vehicle model is used for the trajectory optimization and the periodic guidance law. A numerical example of the optimal periodic loitering is given below.

### Trajectory Optimization

In this section, the optimal periodic loitering trajectory is obtained by solving a constrained functional optimization problem. The cost to be minimized is the ratio of the fuel consumption to endurance over one period as

$$J = \frac{{\int }_{0}^{T} {\dot{m}}_{f} d t}{T}$$

where \dot{m}_{f} is the fuel rate and T is the period. The control variables to be determined are the angle-of-attack α(t), throttle S(t), bank angle φ(t), initial altitude h(0), initial velocity v(0), initial flight path angle γ(0) and period T where tε[0,T]. There are four types of constraints. The first type is the equations of motion of equations 7, 8 and 9. The second type is the periodic constraints which require the initial altitude, velocity and flight path angle to be equal to the final altitude, velocity and flight path angle, respectively, i.e., h(T)=h(0), v(T)=v(0) and γ(T)=γ(0). The third type is the physical constraints on the vehicle. For example, these constraints may include limits on the altitude, velocity, angle-of-attack, throttle and acceleration. The fourth type is the constraint for flying the vehicle in a circle above a point on the ground. Let the desired radius of the circle be r̅. By using r= r̅ and \dot{r}=0, equation 13 and 14 become

$$0 = \frac{{T}_{A} sin α + {T}_{N} cos α + L}{mv cos γ} sin φ - \frac{v}{\overline{r}} cos γ \qquad [ 15 ]$$

Therefore, equation 15 is the constraint for flying the vehicle in a circle with radius of r̅. The optimal periodic loitering trajectory obtained from solving this optimization problem will have periodic altitude, velocity, flight path angle, angle-of-attack, throttle and bank angle and constant r= r̅ and

$$e = \frac{π}{2} or - \frac{π}{2}$$

depending on the vehicle flying counter clockwise or clockwise. Therefore, the optimal periodic loitering trajectory application does not depend on where the vehicle is on the circle.

For this optimization or enhancement solution, it may be assumed that the vehicle mass is given and held fixed over the period. Instead of formulating the optimization problem for single period at fixed vehicle mass, one might formulate a new optimization problem for the entire flight without the periodic constraints using variable vehicle mass (i.e., given initial and final vehicle masses). This will produce the trajectory for the entire flight which may or may not be periodic. However, this is not typically practical implementation because the dimension of this new optimization problem is very large. Therefore, the methods, and apparatus and system described may approximate the large optimization problem by several small optimization problems with periodic constraints using constant vehicle mass assumption. This small approximation leads to an enormous savings in numerical error and computation time. Since the optimal periodic loitering trajectories are obtained for several vehicle masses, a periodic guidance law is described below that mechanizes the optimal or enhanced periodic loitering where the vehicle mass decreases as a result of fuel consumption.

Although this optimization problem is too complicated to be solved analytically, it can be solved numerically by using numerical parameter optimization algorithms. However, this optimization problem is a functional optimization problem because the control variables include the time histories of the angle-of-attack, throttle and bank angle. In order to convert it into a parameter optimization problem, the angle-of-attack, throttle and bank angle are parameterized so that the number of control variables is finite and fixed. The physical constraints on the vehicle are also parameterized so that the number of constraints is also finite and fixed. For the numerical algorithm, the gradients of the cost and constraints with respect to the control variables are determined numerically. Furthermore, the cost and states are obtained by integrating the equations of motion of equations 7, 8 and 9 with linear interpolation between the parameterized angle-of-attack, throttle and bank angle.

### Periodic Guidance Law

In this section, a periodic guidance law that mechanizes the optimal periodic loitering trajectory is described. The periodic guidance law allows the constant vehicle mass assumption used for generating the optimal periodic loitering trajectory to be removed but retain the periodic loitering performance. Note that this periodic guidance law can also mechanize periodic flight that is not optimal. Before designing the periodic guidance law, a set of periodic trajectories are generated for a set of vehicle masses. Then, for each periodic trajectory, a periodic regulator that keeps the vehicle on the periodic trajectory is designed. Finally, in order to handle the decreasing vehicle mass due to fuel consumption, a periodic guidance law is constructed based on the set of periodic regulators.

For notational convenience, let states x and controls u be

$$x {=}^{△} [ \begin{matrix}h \\ v \\ γ \\ r \\ e\end{matrix} ] , u {=}^{△} [ \begin{matrix}α \\ S \\ φ\end{matrix} ] .$$

Then, the equations of motion of equation nos. 7, 8, 9, 13 and 14 are expressed as

\dot{x}=f(x,u). [16]

Denote the states and controls associated with the periodic trajectory (also referred as the nominal trajectory) as x_{N} and u_{N}, respectively. Note that the nominal h, v, γ, α, S and φ are periodic while the nominal r and e are r̅ and π/2, respectively. In order to keep the vehicle on the nominal trajectory (i.e., to regulate x−x_{N}), a periodic regulator is designed for each nominal trajectory.

First, the equations of motion of equation 16 are linearized numerically around the nominal trajectory to obtain the linearized dynamics as

δ\dot{x}(t)=A(t)δx(t)+B(t)+δu(t) [17]

where δx=x−x_{N}, δu=u−u_{N} and

$$A = \frac{\partial f}{\partial x} {\vert}_{x = {x}_{N} , u = {u}_{N}} , B = \frac{\partial f}{\partial u} {\vert}_{x = {x}_{N} , u = {u}_{N}} .$$

Note that the linearized dynamics are periodic because x_{N} and u_{N} are either periodic or constant. That is, A(t+T)=A(t) and B(t+T)=B(t) where T is the period of the nominal trajectory. Then, the periodic regulator is obtained by solving the periodic linear quadratic regulator problem:

$${lim}_{n \to ∞} {min}_{δ u ( t )} \frac{1}{nT} {\int }_{0}^{nT} \frac{1}{2} [ δ {x ( t )}^{T} Q δ x ( t ) + δ {u ( t )}^{T} R δ u ( t ) ] d t$$

subject to equation no. 17 where Q>0 and R>0 are design weightings. By using calculus of variation, the optimal solution is

δu(t)=K(t)δx(t)

where the periodic regulator gain K is

K(t)=−R⁻¹B(t)^{T}π(t) [18]

and the periodic Riccati matrix π satisfies

−\dot{π}(t)=π(t)A(t)+A(t)^{T}π(t)−π(t)B(t)R⁻¹B(t)^{T}π(t)+Q,π(0)=π(T). [19]

Since the periodic regulator is defined on the nominal trajectory and the vehicle may not be on the nominal trajectory, an index point is defined from which the nominal values (i.e., x_{N}, u_{N} and K) required for the periodic regulator are retrieved. The index point can be defined as the point on the nominal trajectory whose altitude, velocity and flight path angle (denoted as x̅_{N} which is part of x_{N}) are closest to the current altitude, velocity and flight path angle (denoted as x̅ which is part of x) in terms of certain criterion. Then, by indexing the nominal trajectory with time, the index time t₁ of the index point can be obtained by solving

$${min}_{{t}_{I} ∈ [ 0 , T ]} {[ \overline{x} ( t ) - {\overline{x}}_{N} ( {t}_{I} ) ]}^{T} \overline{Q} [ \overline{x} ( t ) - {\overline{x}}_{N} ( {t}_{I} ) ]$$

where Q̅>0 is a design weighting. Alternatively, the index time can be obtained by solving

$${{{x}^{\dot{\_}}}_{N} ( {t}_{I} )}^{T} \overline{Q} [ \overline{x} ( t ) - {\overline{x}}_{N} ( {t}_{I} ) ] = 0.$$

Note that r and e are not included in determining the index time because they are constant on the nominal trajectory. Therefore, after using the current altitude, velocity and flight path angle to determine the index time t₁, the nominal states x_{N}, nominal controls u_{N} and the regulator gain K can be obtained to generate the controls u that will keep the vehicle on the nominal trajectory (i.e., δx→0).

After designing the periodic regulators for a set of periodic trajectories associated with a set of vehicle masses, the periodic guidance law is constructed based on these periodic regulators in order to handle the decreasing vehicle mass. First, given the current vehicle mass, the index time on each of the two nominal trajectories associated with the next heavier and lighter vehicle masses is determined. Next, the nominal states, nominal controls and regulator gain on each nominal trajectory are determined. Then, the nominal states, nominal controls and regulator gain for the current vehicle mass are determined by linearly interpolating between the next heavier and lighter vehicle masses using the current vehicle mass. Finally, the controls that will keep the vehicle on the interpolated nominal trajectory are determined. FIG. 1 illustrates in a functional block diagram an exemplary periodic guidance law that may be used to mechanize an optimal or enhanced periodic loitering trajectory. A vehicle 110 such as an air vehicle or aircraft may be characterized by parameters such as measured or estimated mass 112, and measured or estimated vehicle states 114 such as altitude, its velocity vector and position vector relative to the center of the Earth, for example. Such vehicle characteristics 112, 114 may be logged according to a time index store 120 and/or may be tested according to thresholds, for example, to generate one or more time indexes 122. The one or more time indexes 122 from the time index store 120 may be used to draw from a nominal state store 130 nominal or preferred vehicle states 132 which are then compared 140 with the measured or estimated vehicle states 114 and the resulting differences 142 are provided to a regulator gain processor 150 as is the time index 122. The preferred or nominal state control signals or commands 162 may be drawn from a store 160 based on the time index 122. The preferred or nominal state control signals or commands 162 are differenced 170 with the corrections or perturbations in control signals or commands 152 as output by the regulator gain processor 150. The resulting difference signals 172 may be provided as commands to the vehicle 110 so that, as the vehicle follows these commands, via an autopilot for example, the enhanced periodic trajectory may be achieved. Exemplary computer code for an exemplary embodiment of the periodic guidance law in MATLAB® is provided in the Appendix below.

### Exemplary Design Procedure

The design of the periodic guidance law is essentially the design of a set of periodic regulators. Before designing these periodic regulators, a set of periodic trajectories are typically generated for a set of vehicle masses.
Linearize the vehicle dynamics for each vehicle mass. That is, calculate A and B for each vehicle mass using x_{N} and u_{N}.
Choose design weightings Q and R experimentally for each vehicle mass.
Solve the periodic Riccati equation for each vehicle mass. That is, integrate (Equation No. 19) for each vehicle mass using A, B, Q and R with an arbitrary initial condition over several periods until the Riccati matrix π becomes periodic.
Calculate the periodic regulator gain for each vehicle mass by using (Equation No. 18).

### Implementation Procedure

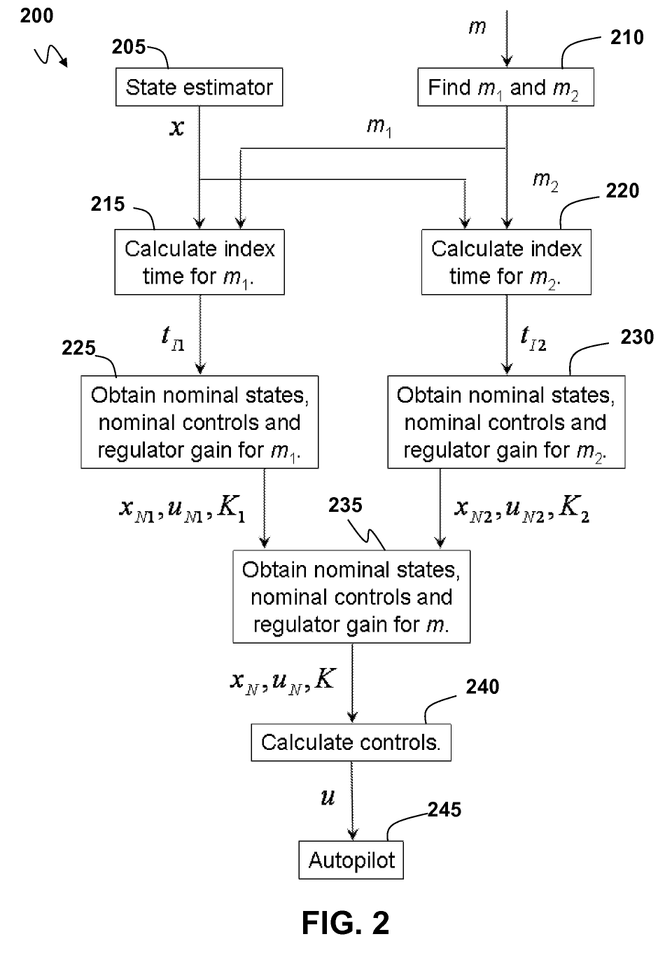

FIG. 2 illustrates an exemplary implementation 200 of the periodic guidance law in a flow diagram. Before implementing the periodic guidance law, the nominal states, nominal controls and the periodic regulator gain for each vehicle mass are stored as functions of the time of each periodic trajectory. Furthermore, the update rate for calculating the controls and the design weighting Q̅ for calculating the index time are chosen. When the controls need to be updated, the periodic guidance law is implemented as follows.
Obtain the input of the periodic guidance law from the state estimator 205: h, v, γ, r and e of the vehicle, i.e., x.
Obtain (step 210) the current vehicle mass m and find the two design vehicle masses m₁ and m₂ that bound the current vehicle mass, i.e., m₁≦m≦m₂. Calculate (step 215, step 220) the index time using x on each of the two trajectories associated with the two design vehicle masses m₁ and m₂.
Obtain the nominal states (step 225, step 230), nominal controls and the periodic regulator gain for each of the two design vehicle masses m₁ and m₂ by using the index time. Denote the two nominal states as x_{N1} and x_{N2}. Denote the two nominal controls as u_{N1} and u_{N2}. Denote the two regulator gains as K₁ and K₂.
Calculate the nominal states, nominal controls (step 235) and the periodic regulator gain for the current vehicle mass by linearly interpolating the two nominal states, two nominal controls and two periodic regulator gains associated with the two design vehicle masses m₁ and m₂ by using the current vehicle mass. That is,

$${x}_{N} = {x}_{N 1} + \frac{{x}_{N 2} - {x}_{N 1}}{{m}_{2} - {m}_{1}} ( m - {m}_{1} )$$

$${u}_{N} = {u}_{N 1} + \frac{{u}_{N 2} - {u}_{N 1}}{{m}_{2} - {m}_{1}} ( m - {m}_{1} )$$

$$K = {K}_{1} + \frac{{K}_{2} - {K}_{1}}{{m}_{2} - {m}_{1}} ( m - {m}_{1} ) .$$

Calculate the perturbed states for the current vehicle mass, i.e., δx=x−x_{N}.
Calculate the perturbed controls for the current vehicle mass, i.e., δu=Kδx.
Calculate the controls (step 240) for the current vehicle mass, i.e., u=u_{N}+δu.
Send the output of the periodic guidance law to the autopilot (step 245), i.e., u.

### Numerical Example

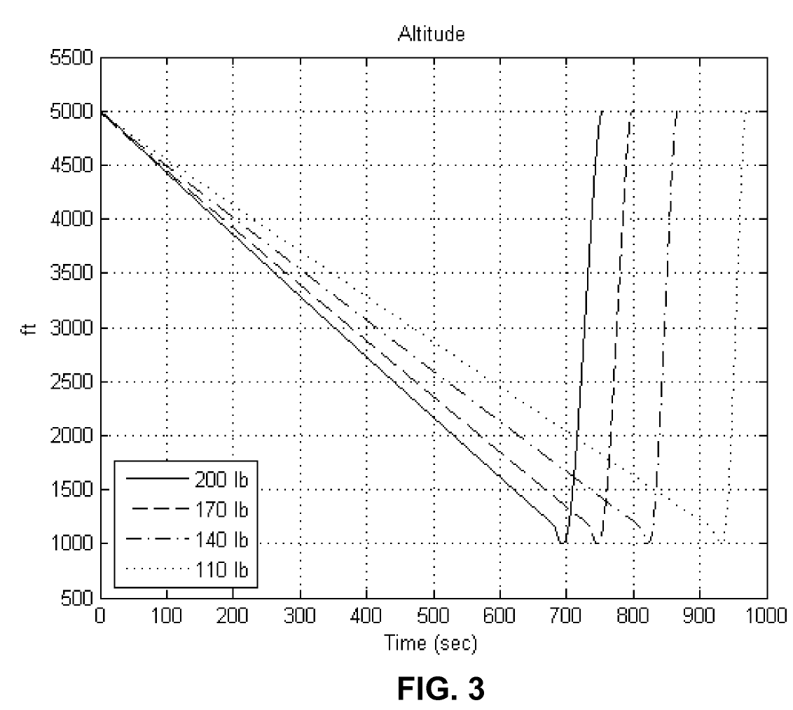

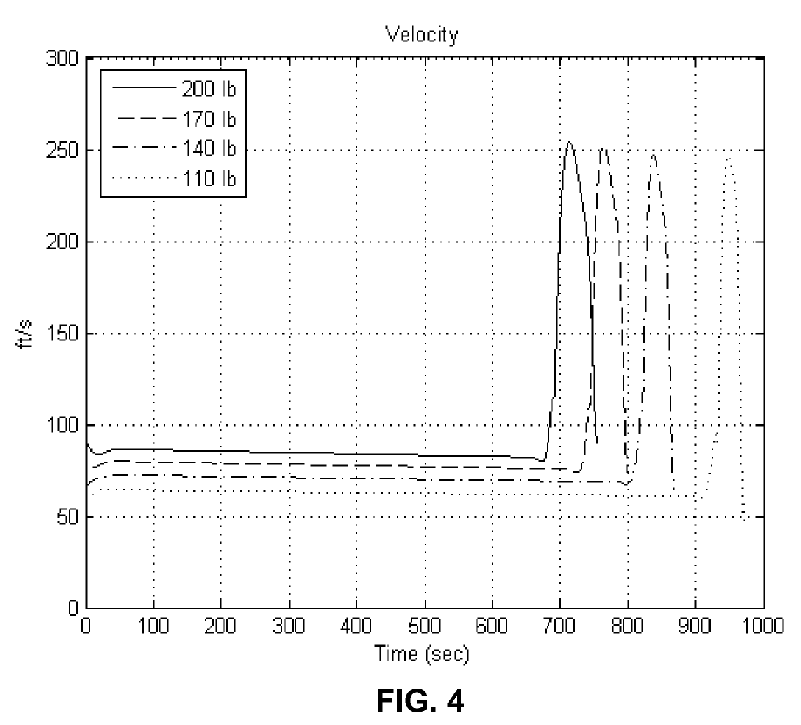

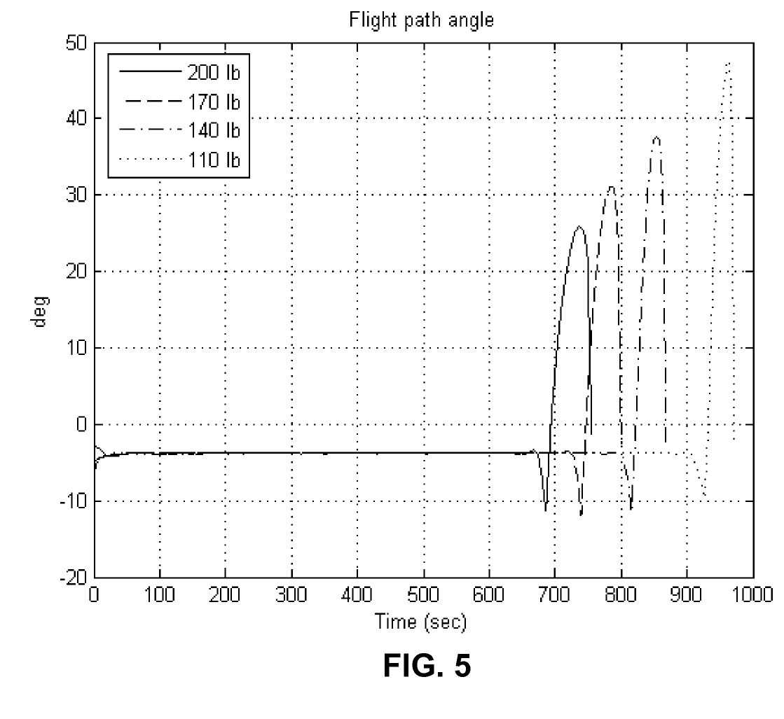

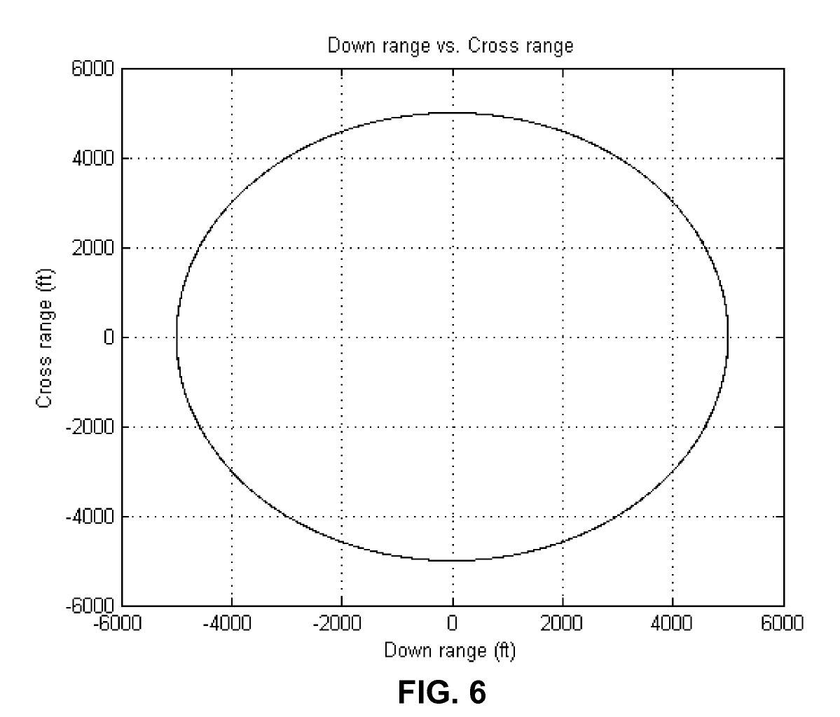

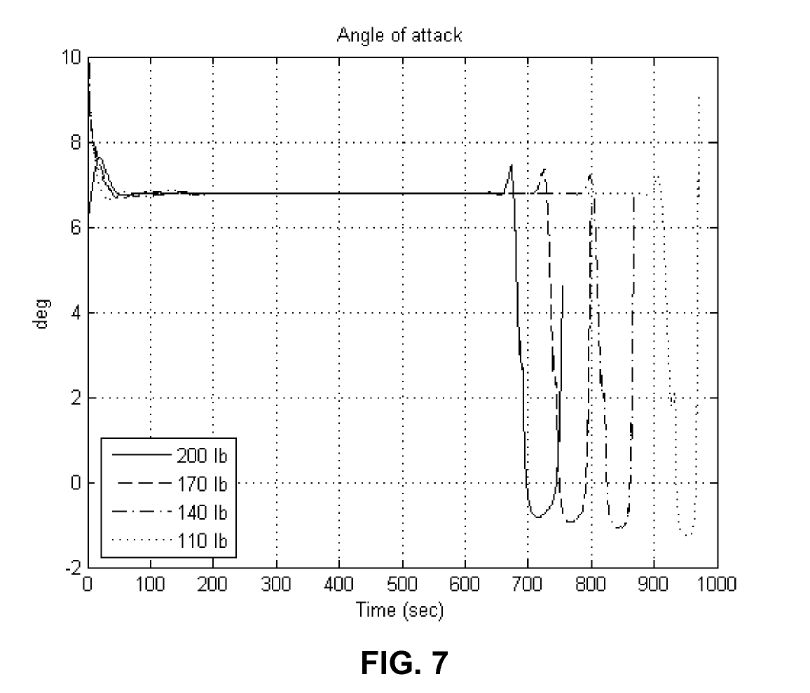

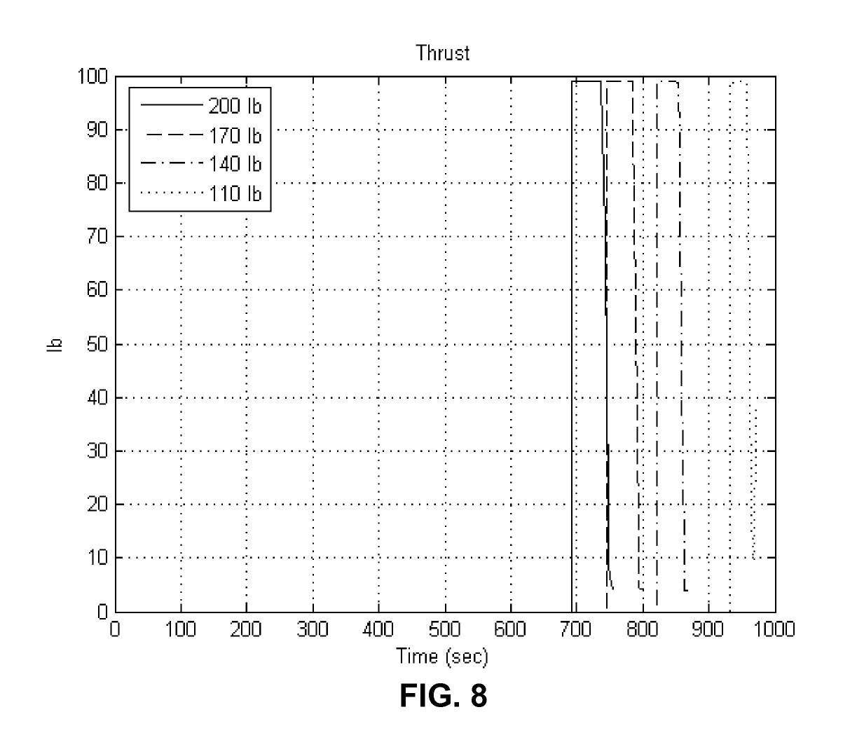

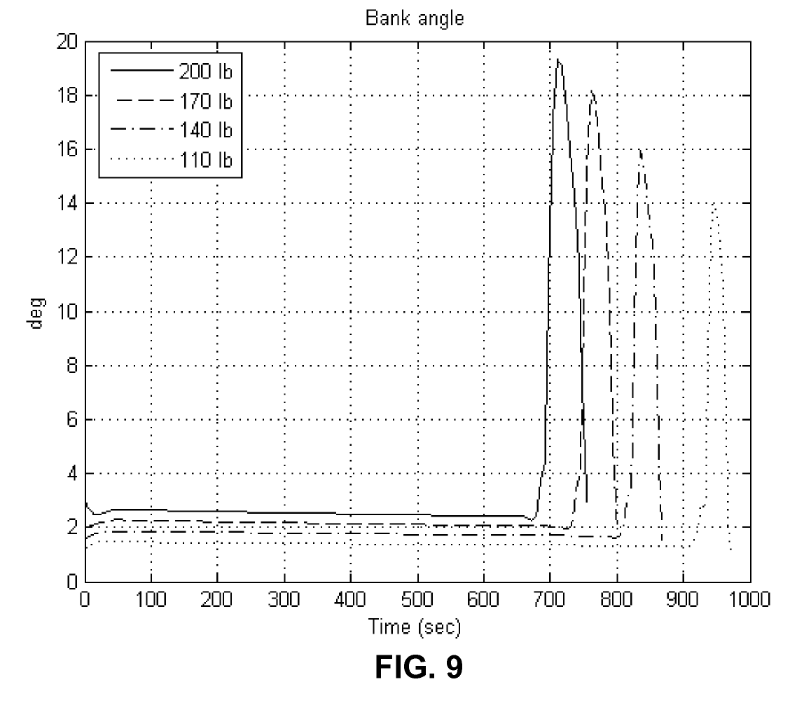

In this section, the trajectory optimization and periodic guidance law for optimal periodic loitering are demonstrated in a numerical example. A small UAV (unmanned air vehicle) with takeoff weight of 190 pounds (lb) and dry weight of 110 lb is used in this example. First, four optimal periodic loitering trajectories are obtained by solving the optimization problem, i.e., executing the steps herein described, with the desired radius of the circle being 5000 feet (ft) at vehicle weight of 200, 170, 140 and 110 lb. These resulting simulated exemplary trajectories are shown in FIGS. 3-10. FIG. 4 illustrates in a graph exemplary periodic loitering trajectories showing velocity versus time. FIG. 5 illustrates in a graph exemplary periodic loitering trajectories showing flight path angle versus time. FIG. 6 illustrates in a graph exemplary periodic loitering trajectories showing down range versus cross range. FIG. 7 illustrates in a graph exemplary periodic loitering trajectories showing angle-of-attack versus time. FIG. 8 illustrates in a graph exemplary periodic loitering trajectories showing thrust versus time. FIG. 9 illustrates in a graph exemplary periodic loitering trajectories showing bank angle versus time;

FIGS. 10A through 10D illustrate in graphs exemplary periodic loitering trajectories showing 3-dimensional views for a 200 pound (lb) cruise weight, a 170 lb cruise weight; 140 lb cruise weight, and a 110 lb cruise weight, respectively.

Four periodic regulators may be designed for these four exemplary periodic trajectories and the periodic guidance law is constructed according to the teachings of the present specification. An exemplary optimal periodic loitering mechanized by the periodic guidance law from vehicle weight of 170 to 153.6 lb is shown in FIGS. 11-18. FIG. 11 illustrates in a graph an exemplary periodic loitering trajectory showing altitude versus time. FIG. 12 illustrates in a graph an exemplary periodic loitering trajectory showing velocity versus time. FIG. 13 illustrates in a graph exemplary periodic loitering trajectories showing flight path angle versus time. FIG. 14 illustrates in a graph exemplary time history of vehicle weight during the execution of an exemplary periodic loitering trajectory. FIG. 15 illustrates in a graph exemplary time history of angle-of-attack during the execution of an exemplary periodic loitering trajectory. FIG. 16 illustrates in a graph exemplary time history of thrust during the execution of an exemplary periodic loitering trajectory. FIG. 17 illustrates in a graph exemplary time history of bank angle during the execution of an exemplary periodic loitering trajectory. FIG. 18 illustrates in a graph an exemplary loitering trajectory showing a 3-dimensional view. It should be understood that while four trajectories are illustrated, the number of trajectories or discrete masses of the vehicle for purposes of periodic guidance processing may vary without limiting the scope of the invention in its several embodiments.

### Optimal Periodic Cruise

In this section, the optimization and mechanization of periodic cruise are described. The objective is to have the vehicle flying straight ahead as further as possible with a given amount of fuel. Since the vehicle flies in a vertical plane, equations no. 1-6 become

$$\begin{matrix}\dot{h} = v sin γ & [ 20 ] \\ \dot{v} = \frac{{T}_{A} cos α - {T}_{N} sin α - D}{m} - g sin γ & [ 21 ] \\ \dot{γ} = \frac{{T}_{A} sin α + {T}_{N} cos α + L}{mv} - \frac{g cos γ}{v} + \frac{v cos γ}{{R}_{e} + h} & [ 22 ] \\ {\dot{r}}_{d} = v cos γ \frac{{R}_{e}}{{R}_{e} + h} . & [ 23 ]\end{matrix}$$

This vehicle model is used for the trajectory optimization and the periodic guidance law. A numerical example of the optimal periodic cruise is provided below.

### Trajectory Optimization

In this section, the optimal periodic cruise trajectory is obtained by solving a constrained functional optimization problem. The cost to be minimized is the ratio of the fuel consumption to range over one period as

$$J = \frac{{\int }_{0}^{T} {\dot{m}}_{f} d t}{{\int }_{0}^{T} {\dot{r}}_{d} d t}$$

where \dot{m}_{f} is the fuel rate and T is the period. The control variables to be determined are the angle-of-attack α(t), throttle S(t), initial altitude h(0), initial velocity v(0), initial flight path angle γ(0) and period T where tε[0,T]. There are three types of constraints. The first type is the equations of motion of equations nos. 20, 21, 22 and 23. The second type is the periodic constraints which require the initial altitude, velocity and flight path angle to be equal to the final altitude, velocity and flight path angle, respectively, i.e., h(T)=h(0), v(T)=v(0) and γ(T)=γ(0). The third type is the physical constraints on the vehicle. For example, these constraints may include limits on the altitude, velocity, angle of attack, throttle, acceleration and dynamic pressure.

As previously described, it may be assumed in the optimization problem that the vehicle mass is given and held fixed over the period. Then, the optimization problem is solved similarly to obtain several optimal periodic cruise trajectories at several vehicle masses. Finally, a periodic guidance law is developed to mechanize the optimal periodic cruise where the vehicle mass decreases as a result of fuel consumption.

### Periodic Guidance Law

In this section, a periodic guidance law that mechanizes the optimal periodic cruise trajectory is described. The periodic guidance law allows the constant vehicle mass assumption used for generating the optimal periodic cruise trajectory to be removed but retain the periodic cruise performance. Note that this periodic guidance law can also mechanize periodic flight that is not optimal. Before designing the periodic guidance law, a set of periodic trajectories are generated for a set of vehicle masses. Then, for each periodic trajectory, a periodic regulator that keeps the vehicle on the periodic trajectory is designed. Finally, in order to handle the decreasing vehicle mass due to fuel consumption, a periodic guidance law is constructed based on the set of periodic regulators.

For notational convenience, let states x and controls u be

$$x {=}^{△} [ \begin{matrix}h \\ v \\ γ\end{matrix} ] , u {=}^{△} [ \begin{matrix}α \\ S\end{matrix} ] .$$

Then, the equations of motion of equation nos. 20, 21 and 22 are expressed as

\dot{x}=f(x,u). [24]

Note that the down range r_{d} is not included because the periodic guidance law does not need to track down range which is decoupled from equation nos. 20, 21 and 22. Denote the states and controls associated with the periodic trajectory (also referred as the nominal trajectory) as x_{N} and u_{N}, respectively. In order to keep the vehicle on the nominal trajectory (i.e., to regulate x−x_{N}), a periodic regulator is designed for each nominal trajectory.

First, the equations of motion of equation no. 24 are linearized numerically around the nominal trajectory to obtain the linearized dynamics as

δ\dot{x}(t)=A(t)δx(t)+B(t)δu(t) [25]

where δx=x−x_{N}, δu=u−u_{N} and

$$A = \frac{\partial f}{\partial x} {\vert}_{x = {x}_{N} , u = {u}_{N}} , B = \frac{\partial f}{\partial u} {\vert}_{x = {x}_{N} , u = {u}_{N}} .$$

Note that the linearized dynamics are typically periodic because x_{N} and u_{N} are typically periodic. That is, A(t+T)=A(t) and B(t+T)=B(t) where T is the period of the nominal trajectory. Then, the periodic regulator is obtained by solving the periodic linear quadratic regulator problem:

$${lim}_{n \to ∞} {min}_{δ u ( t )} \frac{1}{nT} {\int }_{0}^{nT} \frac{1}{2} [ δ {x ( t )}^{T} Q δ x ( t ) + δ {u ( t )}^{T} R δ u ( t ) ] d t$$

subject to equation no. 25 where Q>0 and R>0 are design weightings. By using calculus of variation, the optimal solution is

δu(t)=K(t)x(t)

where the periodic regulator gain K is

K(t)=−R⁻¹B(t)^{T}π(t) [26]

and the periodic Riccati matrix π satisfies

−\dot{π}(t)=π(t)A(t)+A(t)^{T}π(t)−π(t)B(t)R⁻¹B(t)^{T}π(t)+Q,π(0)=π(T). [27]

Since the periodic regulator is defined on the nominal trajectory and the vehicle may not be on the nominal trajectory, an index point is defined from which the nominal values (i.e., x_{N}, u_{N} and K) required for the periodic regulator are retrieved. The index point can be defined as the point on the nominal trajectory whose altitude, velocity and flight path angle (i.e., x_{N}) are closest to the current altitude, velocity and flight path angle (i.e., x) in terms of certain criterion. Then, by indexing the nominal trajectory with time, the index time t₁ of the index point can be obtained by solving

$${min}_{{t}_{I} ∈ [ 0 , T ]} {[ x ( t ) - {x}_{N} ( {t}_{I} ) ]}^{T} \overline{Q} [ x ( t ) - {x}_{N} ( {t}_{I} ) ]$$

where Q̅>0 is a design weighting. Alternatively, the index time can be obtained by solving

\dot{x}_{N}(t_{I})^{T} Q̅[x(t)−x_{N}(t_{I})]=0.

Therefore, after using the current altitude, velocity and flight path angle to determine the index time t₁, the nominal states x_{N}, nominal controls u_{N} and the regulator gain K can be obtained to generate the controls u that will keep the vehicle on the nominal trajectory (i.e., δx→0).

After designing or determining the periodic regulators for a set of periodic trajectories associated with a set of vehicle masses, the periodic guidance law is constructed based on these periodic regulators in order to handle the decreasing vehicle mass. First, given the current vehicle mass, the index time on each of the two nominal trajectories associated with the next heavier and lighter vehicle masses is determined. Then, the nominal states, nominal controls and regulator gain on each nominal trajectory may be determined. Then, the nominal states, nominal controls and regulator gain for the current vehicle mass are determined by linear interpolating between the next heavier and lighter vehicle masses using the current vehicle mass. Finally, the controls that will keep the vehicle on the interpolated nominal trajectory are determined. The periodic guidance law that mechanizes the optimal periodic cruise trajectory may also be described in a functional block diagram as illustrated in FIG. 19. A vehicle 1910 such as an air vehicle or aircraft may be characterized by parameters such as measured or estimated mass 1912, and measured or estimated vehicle states 1914 such as altitude, its velocity vector and position vector relative to the center of the Earth, for example. Such vehicle characteristics 1912, 1914 may be logged according to a time index store 1920 and/or may be tested according to thresholds, for example, to generate one or more time indexes 1922. The one or more time indexes 1922 from the time index store 1920 may be used to draw from a nominal state store 1930 nominal or preferred vehicle states 1932 which are then compared 1940 with the measured or estimated vehicle states 1914 and the resulting differences 1942 are provided to a regulator gain processor 1950 as is the time index 1922. The preferred or nominal state control signals or commands 1962 may be drawn from a store 1960 based on the time index 1922. The preferred or nominal state control signals or commands 1962 are differenced 1970 with the corrections or perturbations in control signals or commands 1952 as output by the regulator gain processor 1950. The resulting difference signals 1972 may be provided as commands to the vehicle 1910 so that, as the vehicle follows these commands, via an autopilot for example, the enhanced periodic trajectory may be achieved. The computer code for the periodic guidance law in MATLAB is provided in the Appendix.

### Design Procedure

The design of the periodic guidance law is essentially the design of a set of periodic regulators. Before designing these periodic regulators, a set of periodic trajectories are generated for a set of vehicle masses as described above.
Linearize the vehicle dynamics for each vehicle mass. That is, calculate A and B for each vehicle mass using x_{N} and u_{N}.
Choose design weightings Q and R experimentally for each vehicle mass.
Solve the periodic Riccati equation for each vehicle mass. That is, integrate equation no. 27 for each vehicle mass using A, B, Q and R with an arbitrary initial condition over several periods until the Riccati matrix π becomes periodic.
Calculate the periodic regulator gain for each vehicle mass by using equation no. 26.

### Implementation Procedure

The implementation of the periodic guidance law is summarized in FIG. 2. Before implementing the periodic guidance law, the nominal states, nominal controls and the periodic regulator gain for each vehicle mass are stored as functions of the time of each periodic trajectory. Furthermore, the update rate for calculating the controls and the design weighting Q̅ for calculating the index time are chosen. When the controls need to be updated, the periodic guidance law is implemented as follows.
Obtain the input of the periodic guidance law from the state estimator: h, v, and γ of the vehicle, i.e., x.
Obtain the current vehicle mass m and find the two design vehicle masses m₁ and m₂ that bound the current vehicle mass, i.e., m₁≦m≦m₂
Calculate the index time using x on each of the two trajectories associated with the two design vehicle masses m₁ and m₂
Obtain the nominal states, nominal controls and the periodic regulator gain for each of the two design vehicle masses m₁ and m₂ by using the index time. Denote the two nominal states as x_{N1} and x_{N2}. Denote the two nominal controls as u_{N1} and u_{N2}. Denote the two regulator gains as K₁ and K₂.
Calculate the nominal states, nominal controls and the periodic regulator gain for the current vehicle mass by linearly interpolating the two nominal states, two nominal controls and two periodic regulator gains associated with the two design vehicle masses m₁ and m₂ by using the current vehicle mass. That is,

$${x}_{N} = {x}_{N 1} + \frac{{x}_{N 2} - {x}_{N 1}}{{m}_{2} - {m}_{1}} ( m - {m}_{1} )$$

$${u}_{N} = {u}_{N 1} + \frac{{u}_{N 2} - {u}_{N 1}}{{m}_{2} - {m}_{1}} ( m - {m}_{1} )$$

$$K = {K}_{1} + \frac{{K}_{2} - {K}_{1}}{{m}_{2} - {m}_{1}} ( m - {m}_{1} ) .$$

Calculate the perturbed states for the current vehicle mass, i.e., δx=x−x_{N}.
Calculate the perturbed controls for the current vehicle mass, i.e., δu=Kδx.
Calculate the controls for the current vehicle mass, i.e., u=u_{N}+δu.
Send the output of the periodic guidance law to the autopilot, i.e., u.

### Numerical Example

In this section, the trajectory optimization and periodic guidance law for optimal periodic cruise are demonstrated in a numerical example. A HCV (hypersonic cruise vehicle) with cruise weight between 330 and 210 klb is used. First, eight optimal periodic cruise trajectories are obtained by solving the optimization problem at vehicle weight of 200, 220, 240, 260, 280, 300, 320 and 340 klb. Then, eight periodic regulators are designed and the periodic guidance law is constructed. The optimal periodic cruise mechanized by the periodic guidance law from vehicle weight of 330 to 210 lb is shown in FIGS. 20 to 25. FIG. 20 illustrates in a graph exemplary periodic cruise trajectory showing altitude versus time. FIG. 21 illustrates in a graph exemplary periodic cruise trajectory showing velocity versus time. FIG. 22 illustrates in a graph exemplary periodic cruise straight ahead trajectory showing flight path angle velocity versus time. FIG. 23 illustrates in a graph exemplary time history of vehicle weight during the execution of an exemplary periodic cruise trajectory. FIG. 24 illustrates in a graph exemplary time history of angle-of attack during the execution of an exemplary periodic cruise trajectory. FIG. 25 illustrates in a graph exemplary time history of throttle during the execution of an exemplary periodic cruise trajectory. It should be understood that while eight discrete masses of the vehicle were illustrated above for purposes of explaining the periodic guidance processing, the actual number of discrete masses may vary when practiced within any of several embodiments of the present invention.

Many alterations and modifications may be made by those having ordinary skill in the art without departing from the spirit and scope of the invention. Therefore, it must be understood that the illustrated embodiments have been set forth only for the purposes of example and that it should not be taken as limiting the invention as defined by the claim following the appendix of exemplary subroutines and steps of exemplary embodiments of the inventions.

What is claimed is:

1. A machine-enabled method of periodic guidance for regulating an air vehicle about a periodic trajectory, the method comprising:
generating a plurality of trajectories comprising time-dependent values including: a time history of one or more vehicle control command values, a plurality of vehicle state values comprising at least one vehicle velocity value, and at least one vehicle altitude value; and wherein the generating of the plurality of trajectories is based on minimizing a predicted fuel consumption per time value using a machine-executable vehicle model, wherein the machine-executable vehicle model includes a lift coefficient and a drag coefficient, and wherein the lift coefficient value and the drag coefficient value are based on a vehicle state value and a vehicle control command value;
generating the periodic trajectory from a portion of at least one of the plurality of generated trajectories comprising the time-dependent values, the periodic trajectory derivation based on a current vehicle state and a current vehicle mass; and
generating one or more air vehicle control system commands based on the output generated periodic trajectory comprising time-dependent values including at least the time history of one or more vehicle control command values.

2. The machine-enabled method of periodic guidance of claim 1 wherein the step of generating a plurality of trajectories is based on a predicted straight line horizontal vehicle flight path.

3. The machine-enabled method of periodic guidance of claim 1 wherein the step of generating a plurality of trajectories is based on a predicted circular horizontal flight path.

4. The machine-enabled method of periodic guidance of claim 1 further comprising, following the step of generating a plurality of trajectories, storing one or more of the plurality of trajectories via a recordable medium configured for stored trajectory retrieval.

5. The machine-enabled method of periodic guidance of claim 1 wherein the step of generating the periodic trajectory from the portion of at least one of the plurality of generated trajectories further comprises interpolating across portions of two or more of the plurality of generated trajectories, and generating the periodic trajectory based on the interpolated portions of the plurality of generated trajectories.

6. The machine-enabled method of periodic guidance of claim 1 wherein the step of generating the periodic trajectory from the portion of at least one of the plurality of generated trajectories further comprises interpolating across portions of two or more of the plurality of generated trajectories using a learning architecture, and generating the periodic trajectory based on the interpolated portions of the plurality of generated trajectories.

7. The machine-enabled method of periodic guidance of claim 1 wherein the step of generating the periodic trajectory from at least one of the plurality of generated trajectories further comprises the periodic trajectory generation based on the current vehicle state, the current vehicle mass, and at least one way point command comprising at least one of latitude, longitude, or altitude.

8. The machine-enabled method of periodic guidance of claim 1 wherein the step of generating a plurality of trajectories using a finite number of control variables is based on at least two values for each control variable.

9. A system for operating an air vehicle along a periodic trajectory comprising:
a navigation computing subsystem configured to estimate the plurality of vehicle states;
a guidance computing subsystem having a computer processor and addressable member, the guidance computing subsystem configured to execute machine-readable instructions to:
generate a plurality of trajectories comprising time-dependent values including at least: a time history of one or more vehicle control command values, a plurality of vehicle state values comprising at least one vehicle velocity value, and at least one vehicle altitude value; and wherein the generation of the plurality of trajectories is based on minimizing a predicted fuel consumption per time value using a machine-executable vehicle model, wherein the machine-executable vehicle model includes at least a lift coefficient and a drag coefficient, and wherein the lift coefficient value and the drag coefficient value are based on a vehicle state value and a vehicle control command value;
generate the periodic trajectory from a portion of at least one of the plurality of generated trajectories comprising the time-dependent values, wherein the periodic trajectory generation is based on a current vehicle state and a current vehicle mass; and
generate one or more air vehicle control system commands based on the output generated periodic trajectory comprising time-dependent values including the time history of one or more vehicle control command values.

10. The system of claim 9 wherein the guidance computing subsystem is further configured to execute machine-readable instructions to generate a plurality of trajectories based on a predicted straight line horizontal vehicle flight path.

11. The system of claim 9 wherein the guidance computing subsystem is further configured to execute machine-readable instructions to generate a plurality of trajectories based on a predicted circular horizontal flight path.

12. The system of claim 9 wherein the guidance computing subsystem is further configured to execute machine-readable instructions to generate the periodic trajectory from portions of two or more of the plurality of generated trajectories by interpolating across the portions of two or more of the plurality of generated trajectories.

13. The system of claim 9 wherein the guidance computing subsystem is further configured to execute machine-readable instructions to generate the periodic trajectory from portions of two or more of the plurality of generated trajectories by interpolating across the portions of two or more of the plurality of generated trajectories using a learning architecture.

14. The system of claim 9 wherein the guidance computing subsystem is further configured to execute machine-readable instructions to store one or more of the plurality of generated trajectories via a recordable medium configured for trajectory selection.

15. The system of claim 9 wherein the guidance computing subsystem is further configured to execute machine-readable instructions to generate the periodic trajectory from portions of two or more of the plurality of generated trajectories by interpolating across two or more of the plurality of generated trajectories using an averaging scheme.

16. The system of claim 9 wherein the guidance computing subsystem is further configured to execute machine-readable instructions to generate the periodic trajectory, the periodic trajectory generation instructions based on the current vehicle state, the current vehicle mass, and at least one way point command comprising at least one of latitude, longitude, or altitude.

17. The system of claim 9 wherein the guidance computing subsystem is further configured to execute machine-readable instructions to generate a plurality of trajectories based upon the finite number of control variables limited to at least two values for each control variable.

18. A machine-enabled method of periodic guidance for regulating an air vehicle about a periodic trajectory, the method comprising:
generating a plurality of trajectories comprising time-dependent values including:
a time history of one or more vehicle control command values, a plurality of vehicle state values comprising at least one vehicle velocity value, and at least one vehicle altitude value; and wherein the generating of the plurality of trajectories is based on maximizing a predicted down range value using a machine-executable vehicle model, wherein the machine-executable vehicle model includes a lift coefficient and a drag coefficient, and wherein the lift coefficient value and the drag coefficient value are based on a vehicle state value and a vehicle control command value;
generating the periodic trajectory from a portion of at least one of the plurality of generated trajectories comprising the time-dependent values, the periodic trajectory derivation based on a current vehicle state and a current vehicle mass; and
generating one or more air vehicle control system commands based on the output generated periodic trajectory comprising time-dependent values including at least the time history of one or more vehicle control command values.

19. The machine-enabled method of periodic guidance of claim 18 wherein the generating of the plurality of trajectories is based on maximizing a predicted down range per unit fuel consumed value.

20. The machine-enabled method of periodic guidance of claim 18 wherein the step of generating a plurality of trajectories is based on a predicted straight line horizontal vehicle flight path.

21. The machine-enabled method of periodic guidance of claim 18 wherein the step of generating a plurality of trajectories is based on a predicted circular horizontal flight path.

22. The machine-enabled method of periodic guidance of claim 18 further comprising, following the step of generating a plurality of trajectories, storing one or more of the plurality of trajectories via a recordable medium configured for stored trajectory retrieval.

23. The machine-enabled method of periodic guidance of claim 18 wherein the step of generating the periodic trajectory from the portion of at least one of the plurality of generated trajectories further comprises interpolating across portions of two or more of the plurality of generated trajectories, and generating the periodic trajectory based on the interpolated portions of the plurality of generated trajectories.

24. The machine-enabled method of periodic guidance of claim 18 wherein the step of generating the periodic trajectory from the portion of at least one of the plurality of generated trajectories further comprises interpolating across portions of two or more of the plurality of generated trajectories using a learning architecture, and generating the periodic trajectory based on the interpolated portions of the plurality of generated trajectories.

25. The machine-enabled method of periodic guidance of claim 18 wherein the step of generating the periodic trajectory from at least one of the plurality of generated trajectories further comprises the periodic trajectory generation based on the current vehicle state, the current vehicle mass, and at least one way point command comprising at least one of latitude, longitude, or altitude.

26. The machine-enabled method of periodic guidance of claim 18 wherein the step of generating a plurality of trajectories using a finite number of control variables is based on at least two values for each control variable.

27. A system for operating an air vehicle along a periodic trajectory comprising:
a navigation computing subsystem configured to estimate the plurality of vehicle states;
a guidance computing subsystem having a computer processor and addressable member, the guidance computing subsystem configured to execute machine-readable instructions to:
generate a plurality of trajectories comprising time-dependent values including at least: a time history of one or more vehicle control command values, a plurality of vehicle state values comprising at least one vehicle velocity value, and at least one vehicle altitude value; and wherein the generation of the plurality of trajectories is based on maximizing a predicted down range value using a machine-executable vehicle model, wherein the machine-executable vehicle model includes at least a lift coefficient and a drag coefficient, and wherein the lift coefficient value and the drag coefficient value are based on a vehicle state value and a vehicle control command value;
generate the periodic trajectory from a portion of at least one of the plurality of generated trajectories comprising the time-dependent values, wherein the periodic trajectory generation is based on a current vehicle state and a current vehicle mass; and
generate one or more air vehicle control system commands based on the output generated periodic trajectory comprising time-dependent values including the time history of one or more vehicle control command values.

28. The system of claim 27 wherein the guidance computing subsystem is further configured to execute machine-readable instructions to generate a plurality of trajectories based on maximizing a predicted down range per unit fuel consumed value.

29. The system of claim 27 wherein the guidance computing subsystem is further configured to execute machine-readable instructions to generate a plurality of trajectories based on a predicted straight line horizontal vehicle flight path.

30. The system of claim 27 wherein the guidance computing subsystem is further configured to execute machine-readable instructions to generate a plurality of trajectories based on a predicted circular horizontal flight path.

31. The system of claim 27 wherein the guidance computing subsystem is further configured to execute machine-readable instructions to generate the periodic trajectory from portions of two or more of the plurality of generated trajectories by interpolating across the portions of two or more of the plurality of generated trajectories.

32. The system of claim 27 wherein the guidance computing subsystem is further configured to execute machine-readable instructions to generate the periodic trajectory from portions of two or more of the plurality of generated trajectories by interpolating across the portions of two or more of the plurality of generated trajectories using a learning architecture.

33. The system of claim 27 wherein the guidance computing subsystem is further configured to execute machine-readable instructions to store one or more of the plurality of generated trajectories via a recordable medium configured for trajectory selection.

34. The system of claim 27 wherein the guidance computing subsystem is further configured to execute machine-readable instructions to generate the periodic trajectory from portions of two or more of the plurality of generated trajectories by interpolating across two or more of the plurality of generated trajectories using an averaging scheme.

35. The system of claim 27 wherein the guidance computing subsystem is further configured to execute machine-readable instructions to generate the periodic trajectory, the periodic trajectory generation instructions based on the current vehicle state, the current vehicle mass, and at least one way point command comprising at least one of latitude, longitude, or altitude.

36. The system of claim 27 wherein the guidance computing subsystem is further configured to execute machine-readable instructions to generate a plurality of trajectories based upon the finite number of control variables limited to at least two values for each control variable.
